(19) United States
(12) Patent Application Publication
(10) Pub. No.: US 2009/0191111 A1
(43) Pub. Date: Jul. 30, 2009

(54) PREPARATION METHOD OF CALCIUM PHOSPHATE-BASED CERAMIC POWDER AND COMPACT THEREOF

(75) Inventors: Nam-Sik Oh, Seoul (KR); Sang-Jin Lee, Mokpo-si (KR); Myung-Hyun Lee, Suwon-si (KR); Sun-Ho Oh, Daegu (KR)

Correspondence Address: LUCAS & MERCANTI, LLP, 475 PARK AVENUE SOUTH, 15TH FLOOR, NEW YORK, NY, 10016, US

(73) Assignee: INHA-INDUSTRY PARTNERSHIP INSTITUTE, Incheon (KR)

(21) Appl. No.: 12/021,920

(22) Filed: Jan. 29, 2008

(51) Int. Cl. C01B 25/26

(52) U.S. Cl. 423/307

(57) ABSTRACT

Disclosed herein is a method of preparing a highly sinterable calcium phosphate-based ceramic powder and a compact thereof. The calcium phosphate-based ceramic powder and compact thereof according to the present invention are advantageous in that they are very biocompatible and economical because they are prepared using natural materials, have nano-sized particles, and are highly sinterable, and thus can be used for bone substitute materials.

### BACKGROUND OF THE INVENTION

1. Field of the Invention

The present invention relates to a method of preparing highly sinterable calcium phosphate-based ceramic powder and a sintered compact thereof and, more particularly, to a method of preparing highly sinterable and nano-sized hydroxyapatite (HAp) powder or β-tricalcium phosphate (β-TCP) powder, which can be usefully used as a bone substitute material because it is highly densified, and a sintered compact thereof.

2. Description of the Related Art

Among next-generation medical technologies, a regenerative medical technique for forming artificial tissues by separating cells from tissues required to be regenerated, culturing the separated cells, transplanting the cultured cells into appropriate biomaterials and then further culturing the transplanted cells has lately attracted considerable attention. In this regenerative medical technique, cell supports are required in order to prevent the transplanted cells from being separated from connective tissues. Therefore, such cell supports are required to have excellent suitability for tissues, the amount of the cell support that is used must not be limited, the form of the cell support must be easily provided, and the provided form thereof must not change for a long time. Furthermore, the cell support must not be an obstacle to the substitution of living tissues for the cell support or the growth of the living tissues.

As conventional cell supports, polymer supports have been commonly used. However, as bone substitute materials attributable to bone loss, calcium phosphate-based ceramic materials, such as hydroxyapatite (HAp), tricalcium phosphate (TCP) and the like, which are inorganic materials similar to the inorganic component of bone, are typically used. These calcium phosphate-based ceramic materials have mechanical strength suitable for bone substitute materials. Brown et al. have researched porous hydroxyapatite (HAp), which is an absorptive inorganic material, Wolf has reported that β-tricalcium phosphate (β-TCP) is slowly decomposed and then replaced by new bone because it has a structure similar to that of the inorganic component of natural bone, and Chow et al. have reported on the osteoconductivity of β-tricalcium phosphate (β-TCP).

Tricalcium phosphate (TCP) undergoes phase transition at a temperature of 1180° C., and includes high-temperature α-TCP and low-temperature β-TCP. The α-TCP is stable at a temperature ranging from 1180 to 1400° C., and is thus chiefly used for bone cement. The β-TCP, which is stable at a temperature of 1180° C. or lower, is effectively used for substitution for bone structure because it has excellent chemical stability and mechanical strength and is readily reabsorbed. In particular, in order to use β-TCP for surgical implantation, the mechanical strength of β-TCP ceramics, if possible, must be high. Therefore, it is important to cause the density of β-TCP to be compact. Generally, in order to increase the density of β-TCP through sintering, β-TCP must be sintered at a temperature lower than the temperature at which β-TCP is transited into α-TCP. However, no attempts to improve the density of β-TCP at a temperature of 1180° C. or lower have been made.

Meanwhile, hydroxyapatite (HAp), which is a typical biomaterial that has been used for a long time, has also been used as a bone substitute because it has high biological activity.

Methods of preparing such calcium phosphate-based ceramic materials are classified into dry methods of preparing the calcium phosphate-based ceramic materials from raw material powder through a solid phase reaction at high temperature and wet methods of preparing the calcium phosphate-based ceramic materials from raw material powder through an aqueous solution reaction at room temperature. In either of these methods, it is important not to form a secondary-phase material, such as CaO, etc. Among the methods, a method of preparing calcium phosphate using calcium nitrate or calcium carbonate, which is a commercially available chemical, as a main raw material of calcium is problematic in that processes are complicated and the product deviates from a stoichiometric composition, and thus the problem in which strength must be improved after sintering remains to be solved.

### SUMMARY OF THE INVENTION

Therefore, the present inventors, researching biocompatible and economical calcium phosphate-based ceramic powder, have prepared highly sinterable, biocompatible and nano-sized calcium phosphate-based ceramic powder using eggshell and phosphoric acid, and found a method of preparing a densified sintered compact using the calcium phosphate-based ceramic powder. Based on this finding, the present invention was completed.

Accordingly, the present invention has been made keeping in mind the above problems occurring in the prior art, and an object of the present invention is to provide a method of preparing highly sinterable, biocompatible and nano-sized calcium phosphate-based ceramic powder using eggshell.

Another object of the present invention is to provide a method of preparing a highly densified calcium phosphate-based ceramic compact.

A further object of the present invention is to provide highly sinterable calcium phosphate-based ceramic powder and a sintered compact thereof.

In order to accomplish the above objects, the present invention provides a method of preparing highly sinterable calcium phosphate-based ceramic powder.

Further, the present invention provides a method of preparing a highly densified calcium phosphate-based ceramic compact.

Furthermore, the present invention provides highly sinterable calcium phosphate-based ceramic powder and a sintered compact thereof.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a graph showing phase development when mixed powder, having a mixing ratio of eggshell to phosphoric acid of 1:1.2 by wt %, is calcined at (a) 700° C., (b) 800° C. and (c) 900° C. for 1 hour, according to an embodiment of the present invention;

FIG. 2 is photographs showing microstructures of (a) eggshell calcined at a temperature of 900° C., (b) hydroxyapatite (HAp) powder which is heat-treated at a temperature of 900° C. for 1 hour, (c) ball-milled hydroxyapatite (HAp) powder and (d) the ball-milled hydroxyapatite (HAp) powder of high power, the microstructures being visualized through scanning electron microscopy (SEM), according to an embodiment of the present invention;

FIG. 3 is a graph showing the densification behavior of a hydroxyapatite (HAp) compact sintered at various sintering temperatures according to an embodiment of the present invention;

FIG. 4 is photographs showing the surfaces of hydroxyapatite (HAp) compacts sintered at (a) 1200° C. and (b) 1300° C. for 1 hour according to an embodiment of the present invention;

FIG. 5 is photographs showing microstructures of (a) eggshell calcined at a temperature of 800° C., (b) β-tricalcium phosphate (TCP) powder prepared at a temperature of 900° C, (c) β-tricalcium phosphate (TCP) powder prepared at a temperature of 900° C by adding polyethylene glycol (PEG) thereto at a ratio of 3:1 and (d) β-tricalcium phosphate (TCP) powder prepared at a temperature of 900° C. by adding polyethylene glycol (PEG) thereto at a ratio of 1:1, the microstructures being visualized through scanning electron microscopy (SEM), according to an embodiment of the present invention;

FIG. 6 is photographs showing microstructures of the (a) surface and (b) section of a compact sintered at a temperature of 1150° C. using β-TCP powder prepared without adding PEG thereto, the microstructures being visualized through scanning electron microscopy (SEM), according to an embodiment of the present invention; and

FIG. 7 is photographs showing microstructures of the (a) surface and (b) section of a compact sintered at a temperature of 1150° C. using β-TCP powder prepared by adding PEG thereto at a ratio of 3:1, the microstructures being visualized through scanning electron microscopy (SEM), according to an embodiment of the present invention.

### DESCRIPTION OF THE PREFERRED EMBODIMENTS

Hereinafter preferred embodiments of the present invention will be described in detail.

The present invention provides a method of preparing highly sinterable calcium phosphate-based ceramic powder. In this case, the calcium phosphate-based ceramic powder may be hydroxyapatite (HAp) powder or β-tricalcium phosphate (β-TCP).

In the method of preparing highly sinterable calcium phosphate-based ceramic powder according to the present invention, the HAp powder may be prepared through a method comprising the steps of calcining washed raw eggshell (step 1); adding a phosphoric acid solution to the calcined eggshell in an isopropyl alcohol solvent and then pulverizing the eggshell to form a mixed slurry (step 2); and drying, calcining the mixed slurry to form powder, and then further pulverizing the synthesized powder to form fine powder (step 3).

Here, first, step 1 is a step of calcining washed raw eggshell. That is, in this step, raw eggshell is washed and then calcined at a temperature of 800˜900° C. for 1 hour. The eggshell is composed of calcium carbonate (CaCO₃), which is a calcareous material, and when the eggshell is calcined in air at a temperature of 800° C., it is decomposed into calcium oxide (CaO).

Second, step 2 is a step of adding a phosphoric acid solution to the calcined eggshell in an isopropyl alcohol solvent and then pulverizing the eggshell to form mixed slurry. The mixing ratio of the calcined eggshell to the phosphoric acid solution may range from 1:1.0 to 1:1.2 by weight in order to prepare hydroxyapatite (HAp) powder. When the mixing ratio thereof is below 1:1.0, there is a problem in that calcium oxide (CaO) remains after the reaction. In contrast, when the mixing ratio thereof is above 1:1.2, there is a problem in that another second phase, such as a β-TCP phase, is formed.

The pulverizing of the calcined eggshell in step 2 may be conducted through ball-milling, but is not limited thereto. Ball milling is wet milling that is conducted in an isopropyl alcohol solvent. Ball milling may be conducted for 12 hours using zirconia (Y-TZP) balls in order to prevent eggshell powder from being agglomerated, to pulverize the eggshell powder smaller, and to uniformly mix the eggshell powder with the phosphoric acid solution.

Third, step 3 is a step of drying, calcining the mixed slurry formed in step 2 to form powder and then further pulverizing the synthesized powder to obtain fine powder. The calcining of the mixed slurry may be conducted at atmospheric pressure at a temperature of 850˜950° C. for 0.5˜2 hours. The pulverizing of the synthesized powder may be conducted through ball-milling, but is not limited thereto. Ball milling is wet milling. Ball milling may be conducted in an isopropyl alcohol solvent for 12 hours using zirconia (Y-TZP) balls. In this case, the HAp powder obtained through wet milling is not agglomerated, and the particle size of the HAp powder is decreased to about 0.1 μm or less.

Further, in the method of preparing highly sinterable calcium phosphate-based ceramic powder according to the present invention, the β-TCP powder may be prepared through a method comprising the steps of calcining washed raw eggshell (step A); adding a phosphoric acid solution to the calcined eggshell in an isopropyl alcohol solvent and then pulverizing the eggshell to form a mixture (step B); adding polymer powder to the pulverized mixture and then stirring the mixture to form a gel solution (step C); and drying the gel solution, calcining it to form powder, and then further pulverizing the synthesized powder to form fine powder (step D).

Here, first, step A is a step of calcining washed raw eggshell. That is, in this step, raw eggshell is washed and then calcined at a temperature of 800˜900° C. for 1 hour. The eggshell is composed of calcium carbonate (CaCO₃), which is a calcareous material, and when the eggshell is calcined in air at a temperature of 800° C., it is decomposed into calcium oxide (CaO).

Second, step B is a step of adding a phosphoric acid solution to the eggshell powder calcined from step A in an isopropyl alcohol solvent and then pulverizing the eggshell to form a mixture. The mixing ratio of the calcined eggshell to the phosphoric acid solution may range from 1:1.3 to 1:1.7 by weight, and preferably from 1:1.3 to 1:1.5 by weight in order to prepare β-TCP powder. When the mixing ratio thereof is below 1:1.3, there is a problem in that HAp powder is formed instead of β-TCP powder. In contrast, when the mixing ratio thereof is above 1:1.7, there is a problem in that another second phase, such as a phosphoric acid-mixed crystal phase that is unknown, is formed together with β-TCP.

The pilverizing of the calcined eggshell in step B may be conducted through ball milling, but is not limited thereto. Ball milling is wet milling that is conducted in an isopropyl alcohol solvent. Ball milling may be conducted for 12 hours using zirconia (Y-TZP) balls in order to prevent eggshell powder from being agglomerated, to pulverize the eggshell powder smaller, and to uniformly mix the eggshell powder with the phosphoric acid solution.

Third, step C is a step of adding polymer powder to the mixture pulverized in step B and then stirring the mixture to form a gel solution. It is preferred that the polymer be easily dissolved in an isopropyl alcohol solvent and that it be completely removed in the following step D of calcining the gel solution. For example, polyethylene glycol (PEG) may be used as the polymer. In this case, the particle size of the β-TCP powder prepared by adding PEG to the pulverized mixture in step B is decreased, and pores are formed in sites from which PEG is removed through the calcination process, so that powder become soft and milling can be easily conducted.

In step C, the weight ratio of total calcium ions to the polymer may range from 3:1 to 1:1. The particle size of the powder prepared using the polymer is decreased to half of the particle size of the powder prepared without using the polymer. The reason is that long chains of the polymer surround and protect cations and sol particles, so that the contact between cations is prevented, thereby inhibiting the agglomeration and precipitation therebetween. When the weight ratio of total calcium ions to the polymer is below 3:1, there is a problem in that the expected effect of the addition of PEG is slight. In contrast, when the weight ratio of total calcium ions to the polymer is above 3:1, there are problems in that the polymer may not be completely removed through the calcination process, and in that the effect of decreasing the particle size of the powder cannot be observed, or, in some cases, the dispersion of cations is prevented, so that large-sized particles are partially formed, thereby forming nonuniform particles.

The molecular weight of the polymer may be 500˜3500. The porosity and pore size of the β-TCP powder of the present invention may be influenced by the molecular weight thereof.

In step C of stirring, the isopropyl alcohol solvent is slowly evaporated from the mixture solution, so that the viscosity of the mixture solution is increased, with the result that the mixture solution is changed from a sol state to a gel state.

Fourth, step D is a step of drying, calcining the gel solution prepared in the step C to form powder and then further pulverizing the synthesized powder to obtain fine powder. The calcining of the gel solution in step D may be conducted at atmospheric pressure at a temperature of 850˜950° C. for 0.5˜2 hours. The pulverizing of the synthesized powder in step D may be conducted through ball-milling, but is not limited thereto. Ball milling is wet milling. Ball milling may be conducted in an isopropyl alcohol solvent for 12 hours using zirconia (Y-TZP) balls. In this case, the β-TCP powder obtained through the wet milling is not agglomerated, and the particle size of the β-TCP powder is decreased to about 0.1 μm or less.

Further, the present invention provides a method of preparing a highly densified calcium phosphate-based ceramic compact, further including the step of molding and sintering the calcium phosphate-based ceramic powder.

The highly densified calcium phosphate-based ceramic compact can be obtained by molding and sintering the calcium phosphate-based ceramic powder prepared using the preparation method thereof according to the present invention. In this method, the calcium phosphate-based ceramic powder is uni-axially molded at a pressure of 10 MPa into a compact, and then the compact may be sintered at a temperature of 1200˜1300° C. for 0.5˜2 hours when it is composed of HAp powder and may be sintered at a temperature of 1120˜1180° C. for 0.5˜2 hours when it is composed of β-TOP powder. It is preferred that, when the compact is composed of β-TCP powder, the sintering of the compact be conducted at the temperature lower than the phase-transition temperature (1180° C.) of β-TCP in order to prevent β-TCP from undergoing phase transition into α-TCP.

Furthermore, the present invention provides a highly sinterable calcium phosphate-based ceramic powder and a compact thereof, which are prepared using the method of preparing the calcium phosphate-based ceramic powder and the method of preparing the compact thereof, respectively.

The particle size of the calcium phosphate-based ceramic powder may be 50˜500 nm, and the average particle size thereof after milling is about 100 nm. Further, the specific surface area of the calcium phosphate-based ceramic powder may be 50˜70 m²/g. The porous compact, prepared using the calcium phosphate-based ceramic powder having the particle size and specific surface area through the molding and sintering processes, when it is transplanted in living organisms, provides a large specific surface area and pore volume, so that pore spaces can be efficiently used, and body fluids, oxygen, nutrients, and the like pass through pores freely, with the result that the formation of new bones is accelerated, and the healing effect is increased, and thus the porous compact is very effectively used as a bone support.

According to the method of preparing the calcium phosphate-based ceramic powder of the present invention, calcium phosphate-based ceramic powder, which has smaller-sized (nano-sized) particles and exhibits high sinterability, can be prepared. As the results of analysis of the microstructure of the calcium phosphate-based ceramic powder of the present invention and the measurement of the specific surface area thereof, it can be seen that the calcium phosphate-based ceramic powder, particularly, the HAp powder, is formed into a powder having an average particle size of 50˜100 nm. Further, it can be seen that the calcium phosphate-based ceramic powder prepared by adding PEG such that the weight ratio of total calcium ions to PEG is 3:1, particularly, the β-TCP powder, is formed into a highly densified calcium phosphate-based ceramic powder having an average particle size of 200˜300 nm and a high specific surface area of 57 m²/g. The calcium phosphate-based ceramic powder prepared by adding PEG can be highly densified by sintering it at a temperature of 1150° C. for 1 hour. Therefore, it can be seen that PEG cause cations in precursors to be easily dispersed and mixed. Further, the phase transition of β-TCP into α-TCP, which can occur in a high-temperature sintering process, can be efficiently prevented by sintering the powder at a temperature lower than the phase transition temperature of β-TCP.

Hereinafter, the present invention will be described in detail with reference to Examples and drawings. A better understanding of the present invention may be obtained through the following examples which are set forth to illustrate, but are not to be construed as the limit of the present invention.

### EXAMPLE 1

### Preparation of HAp Compact

Washed raw eggshell was calcined in atmospheric pressure at a temperature of 900° C. for 1 hour to form a mixture.

In this example, the weight ratio of the eggshell to phosphoric acid ranged from 1:1.0 to 1:1.3, and isopropyl alcohol was used as a solvent. Subsequently, the mixture was ball-milled using zirconia (Y-TZP) balls for 12 hours in order to prevent the agglomeration of the mixture and uniformly mix the eggshell with the phosphoric acid. Thereafter, the ball-milled mixture was dried at a temperature of 90˜100° C. for 24 hours and then heated at a heating rate of 4° C./min in air to form a HAp powder. Subsequently, the HAp powder was ball-milled using the zirconia balls in the isopropyl alcohol solvent for 2 hours. Thereafter, the ball-milled HAp powder was molded by uni-axially applying a pressure of 10 MPa thereto, and then sintered at a temperature of 1200˜1300° C. for 1 hour, thereby obtaining a HAp compact.

### EXAMPLE 2

### Preparation 1 of β-TCP Compact

Washed raw eggshell was calcined in atmospheric pressure at a temperature of 800° C. for 1 hour, and then the calcined eggshell was mixed with phosphoric acid to form a mixture. In this case, the weight ratio of the eggshell to the phosphoric acid ranged from 1:1.0 to 1:1.7, and isopropyl alcohol was used as a solvent. Subsequently, the mixture was ball-milled using zirconia (Y-TZP) balls for 12 hours in order to prevent the agglomeration of the mixture and uniformly mix the eggshell with the phosphoric acid. Thereafter, polyethylene glycol (PEG, M.W. 2000) was added to the ball-milled mixture such that the weight ratio of total metal ions to PEG was 3:1 to form a sol-state mixed slurry, and then the mixed slurry was dried. In this example, the sol-stated mixed slurry was changed into a fragile gel-state mixture because isopropyl alcohol was evaporated from the mixed slurry, and thus the viscosity of the mixed slurry was increased. Subsequently, the dried gel-state mixture was calcined at a temperature of 900° C. for 1 hour in an atmospheric pressure to form a β-TCP powder. Subsequently, the β-TCP powder was ball-milled using the zirconia ball in the isopropyl alcohol solvent for 6 hours. Thereafter, the ball-milled β-TCP powder was molded by uni-axially applying a pressure of 10 MPa thereto, and was then sintered at a temperature of 1150° C. for 1 hour, thereby obtaining a β-TCP compact.

### EXAMPLE 3

### Preparation 2 of β-TCP Compact

A β-TCP compact was obtained using the same method as in Example 1, except that polyethylene glycol (PEG) was added to the ball-milled mixture such that the weight ratio of total calcium ions to PEG was 1:1.

### EXAMPLE 4

### Preparation 3 of β-TCP Compact

A β-TCP compact was obtained using the same method as in Example 1, except that the ball-milled mixture was dried without adding polyethylene glycol (PEG) to the ball-milled mixture.

### EXPERIMENTAL EXAMPLE 1

### Analysis of Crystal Phase of Calcium Phosphate-Based Ceramic Powder

The development of crystalline phase of the powder synthesized by the action according to the mixing ratio of eggshell was examined using CuKα characteristics X-ray wavelengths in X-ray diffraction (XRD, Rigaku D/Max 2200) on the condition of 40 kV and 30 mA. Further, the molar ratio of calcium to phosphorus according to the mixing ratio thereof in the powder was evaluated by chemical analysis using ICP AES (spectrogram EOF).

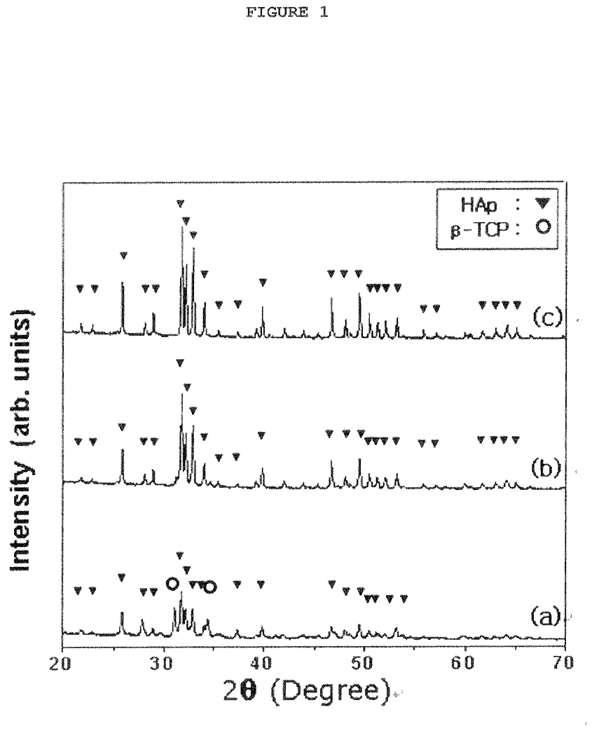

The mixing ratio (weight ratio) of the calcined eggshell to the phosphoric acid solution has an influence on the final crystal phase of the calcium phosphate-based ceramic powder. The final crystal phase of the calcium phosphate-based ceramic powder according to the molar ratio of calcium to phosphorus was shown in Table 1 and FIG. 1.

TABLE 1

| Mixing ratio | Molar ratio of calcium | |
|---|---|---|
| (weight ratio) | to phosphorus | Observed phase^{¥} |
| 1:1.0 | 1.89 | Hap + CaO |
| 1:1.1 | 1.77 | HAp + (CaO) |
| 1:1.2 | 1.65 | HAp |
| 1:1.3 | 1.57 | β − TCP |
| 1:1.4 | 1.49 | β − TCP |
| 1:1.5 | 1.41 | β − TCP |
| 1:1.6 | 1.33 | β − TCP + unknown phase |
| 1:1.7 | 1.24 | β − TCP + unknown phase |

^{¥}based on the sample heated at 900° C. for 1 hour
( ): very slightly observed phase

As shown in Table 1 and FIG. 1, it was found that HAp was formed when the mixing ratio thereof ranged from 1:1.0 to 1:1.2, and unreacted CaO was formed when the amount of phosphorus was small (referring to FIGS. 1A and 1B). Further, β-TCP was formed when the mixing ratio thereof was 1:1.3 or more (referring to FIG. 1C). Specifically, it was found that β-TCP was formed as expected when the mixing ratio thereof ranged from 1:1.3 to 1:1.5 by weight, and the intensity of β-TCP peaks was decreased and unexplained peaks were also observed when the mixing ratio thereof ranged from 1:1.6 to 1:1.7 by weight. The above crystallinity of the powder was exhibited even when β-TCP powder was formed using PEG, regardless of the amount of PEG.

Since the amount of original phosphoric acid may be decreased through mixing and drying processes, the mixing ratio of calcium to phosphorus may differ from the initial mixing ratio. Therefore, it can be predicted that the mixing ratio of calcium to phosphorus in HAp (1.66 stoichiometric ratio) ranges from 1:1.1 to 1:1.2, and the mixing ratio thereof in β-TCP (1.50 stoichiometric ratio) ranges from 1:1.3 to 1:1.5.

### EXPERIMENTAL EXAMPLE 2

### Analysis of Microstructures of Calcium Phosphate-Based Ceramic Powder and Compact Thereof

Samples of the calcium phosphate-based ceramic powder and the compact thereof were observed using a scanning electron microscope (SEM, HITACHI S-3500N) in order to analyze the microstructures thereof. The samples were loaded onto aluminum stubs and then coated at a current of 15 mA for 40 seconds using an Au—Pd sputter.

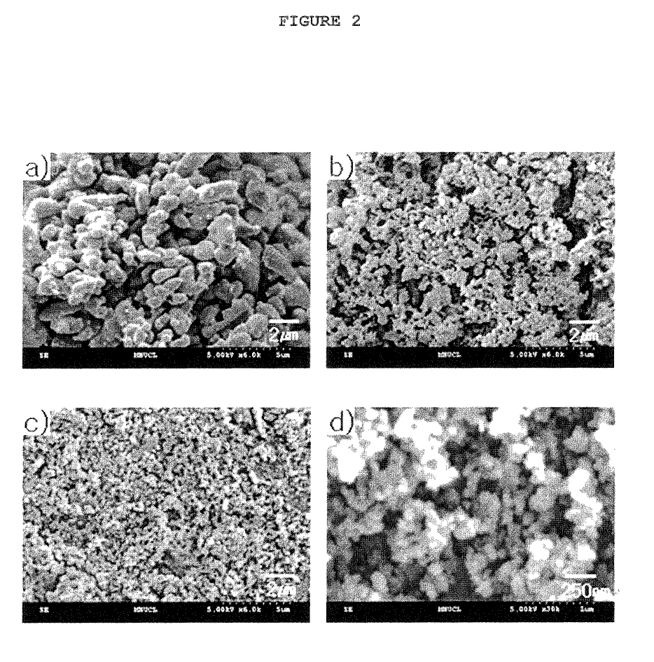

The microstructures of the calcined eggshell and the formed HAp powder are shown in FIG. 2. In the microstructure of the eggshell calcined at 900° C., grape-shaped particles having an average particle size of 1.0 μm were shown (see FIG. 2A). In the microstructure of the formed HAp powder, the particle size of the HAp powder was decreased to an ultra-fine size, and the HAp powder was entirely agglomerated (see FIG. 2B). The agglomerated HAp powder can be easily formed into fine powder through a ball-milling process, and it was found that the particle size of the ball-milled fine powder was about 50˜100 nm (see FIG. 2D).

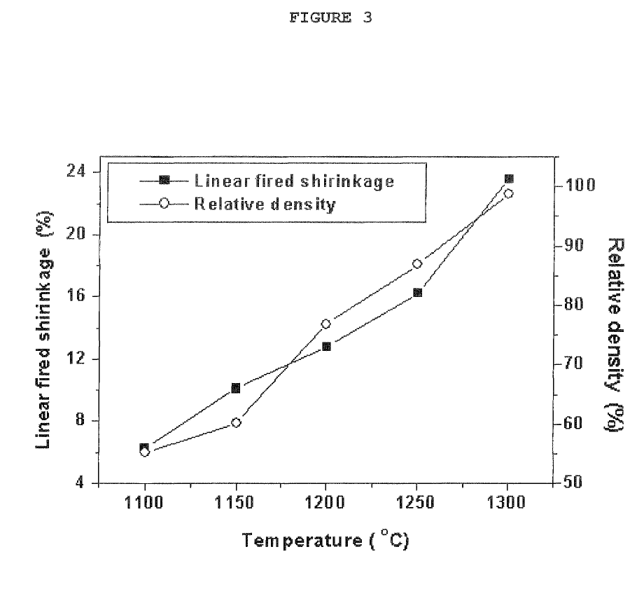

The shrinkage and densification of the sintered powder was shown in FIG. 3. As shown in FIG. 3, the shrinkage of the sintered powder increased roughly linearly, and was maximum at a temperature of 1250˜1300° C. In particular, it can be seen that the relative density of the powder was increased to 99%.

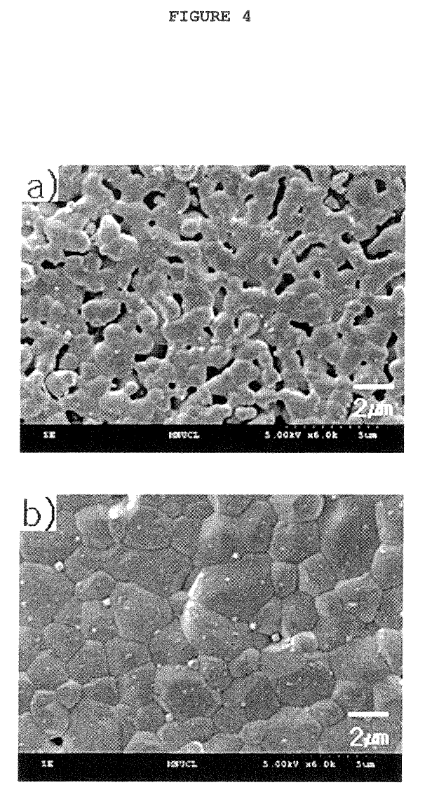

Meanwhile, the result of observation of the compact of the powder using SEM was shown in FIG. 4. FIG. 4A shows the microstructure of the compact sintered at 1200° C. for 1 hour. As shown in FIG. 4B, it was found that a HAp compact was completely densified, the particle size thereof was 2.0 μm, and particles grew considerably.

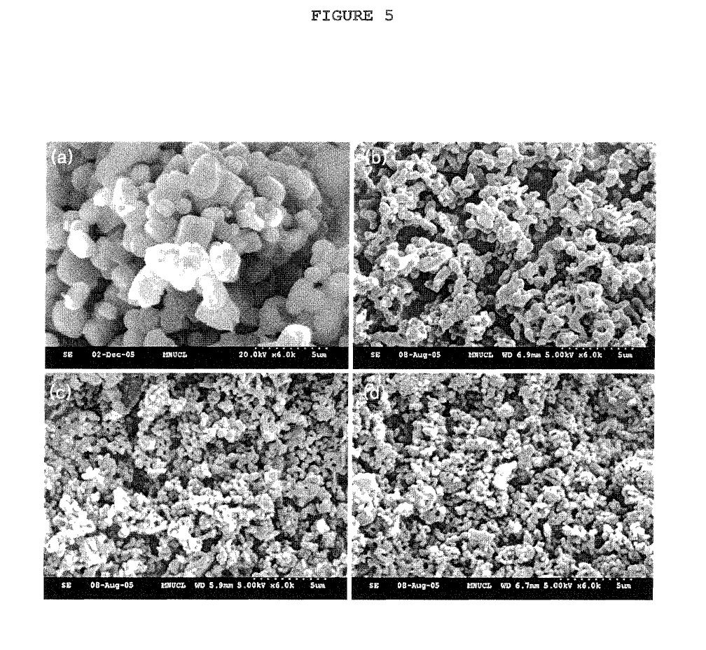

Meanwhile, the microstructures of the calcined eggshell and the β-TCP powder prepared depending on the amount of PEG at 900° C. are shown in FIG. 5. In the microstructure of the eggshell calcined at 800° C., grape-shaped particles having a particle size of 1.0˜2.0 μm were shown (see FIG. 5A). In the microstructure of the β-TCP powder, the mixing ratio of calcium to phosphorus of which is 1:1.5, the particle size of the β-TCP powder was decreased depending on the addition of PEG. It was found that the particle size of the β-TCP powder (Example 3), having a mixing ratio of calcium to phosphorus of 1:1, was greatly decreased, compared to the particle size of the β-TCP powder (Example 4) prepared without using PEG. In particular, it was found that the particle size of the β-TCP powder (Example 2) having a mixing ratio of calcium to phosphorus of 1:3 was about 0.2μ0.3 μm, which is half or less of the particle size of the β-TCP powder (Example 4) prepared without using PEG (see FIGS. 5B, 5C and 5D).

Highly-sinterable β-TCP powder can be obtained by adding a selected polymer during processing and then performing a calcination process at a temperature of 900° C. The long chains of the added polymer (PEG) serve to prevent anions from coming close to each other and to suppress the agglomeration and precipitation thereof. For this reason, the β-TCP powder can have good particulate form and quality when PEG is added. That is, powder having a small particle size and high sinterability can be obtained when the β-TCP powder is prepared using PEG.

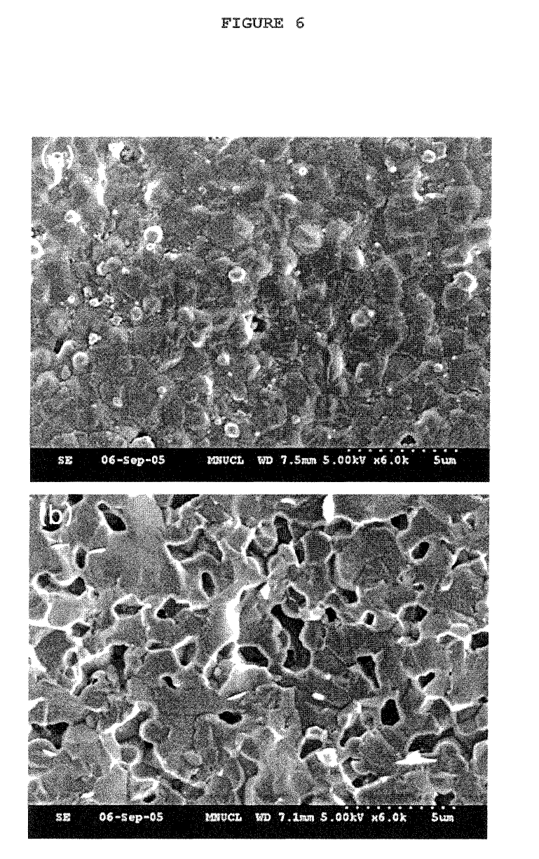

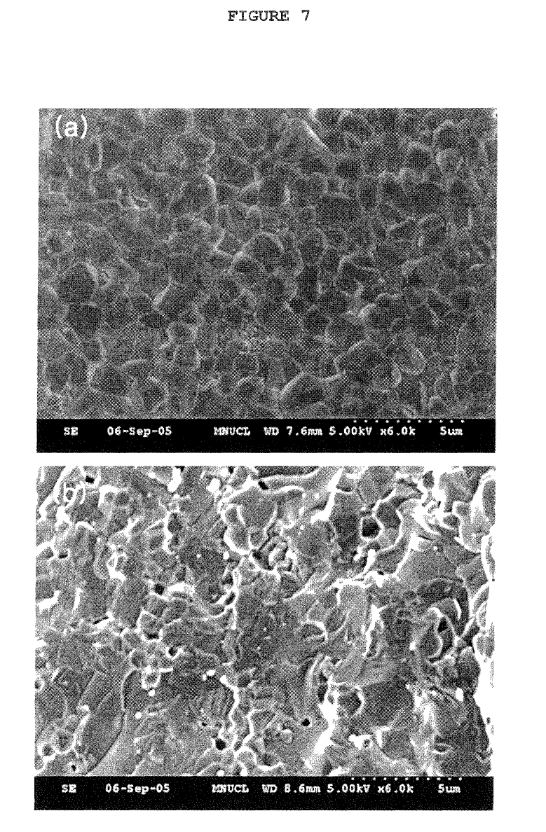

FIG. 6 shows the microstructures of the (a) surface and (b) section of a compact sintered at a temperature of 1150° C. using β-TCP powder prepared without adding PEG thereto, the microstructures being visualized through scanning electron microscopy (SEM), and FIG. 7 shows the microstructures of the (a) surface and (b) section of a compact sintered at a temperature of 1150° C. using β-TCP powder prepared by adding PEG thereto at a ratio of 3:1, the microstructures being visualized through scanning electron microscopy (SEM). As shown in FIGS. 6 arid 7, it can be seen that, since the above β-TCP compacts were sintered in order to prevent them from undergoing phase transition into α-TCP compacts, the β-TCP compact prepared by adding PEG exhibits uniform grain distribution, compared to the β-TCP compact prepared without using PEG, and is a densified compact having a comparatively uniform grain size. As the result of XRD analysis of the β-TCP compact, only β-TCP was observed. From the result thereof, it is determined that the existence of β-TCP of the compact sintered at 1150° C. is based on the control of the sintering temperature, rather then several scientific theories in which the formation of α-TCP is inhibited at temperatures of 1180° C. or higher when the mixing ratio of calcium to phosphorus deviates from the stoichiometric ratio. The reason is that the β-TCP compact was sintered at a temperature lower than the temperature at which β-TCP is transited into α-TCP.

### EXPERIMENTAL EXAMPLE 3

### Measurement of Specific Surface Area of β-TCP Powder

The specific surface area of β-TCP powder was measured through five-point BET analysis (Model Autosorb-1, Boynton Beach, Fla.)

From the result of measurement of the specific surface area of ⊖-TCP powder, it can be seen that the β-TCP powder, prepared by adding PEG thereto at a ratio of 3:1, is formed into a highly sinterable β-TCP powder having a high specific surface area of 57 m²/g.

As described above, the calcium phosphate-based ceramic powder and compact thereof according to the present invention are advantageous in that they are very biocompatible and economical because they are prepared using natural materials, have nano-sized particles, and are highly sinterable, and thus they can be used for bone substitute materials.

As described above, although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of preparing highly sinterable calcium phosphate-based ceramic powder.

2. The method according to claim 1, wherein the calcium phosphate-based ceramic powder is hydroxyapatite (HAp) powder or β-tricalcium phosphate (β-TCP).

3. The method according to claim 2, wherein the hydroxyapatite (HAp) powder is prepared by:
calcining washed raw eggshell;
adding a phosphoric acid solution to the calcined eggshell in an isopropyl alcohol solvent and then pulverizing the eggshell to form a mixed slurry; and
drying, calcining the mixed slurry to form powder, and then further pulverizing the synthesized powder to form fine powder.

4. The method according to claim 3, wherein, in the adding a phosphoric acid solution, a mixing ratio of the eggshell to the phosphoric acid solution ranges from 1:1.0 to 1:1.2 by weight.

5. The method according to claim 3, wherein the calcining the mixed slurry is conducted at atmospheric pressure at a temperature of 850˜950° C. for 0.5˜2 hours.

6. The method according to claim 2, wherein the β-TCP powder is prepared by:
calcining washed raw eggshell;
adding a phosphoric acid solution to the calcined eggshell in an isopropyl alcohol solvent and then pulverizing the eggshell to form a mixture;
adding polymer powder to the pulverized mixture and then stirring the mixture to form a gel solution; and
drying, calcining the gel solution to form powder, and then further pulverizing the synthesized powder to form fine powder.

7. The method according to claim 6, wherein, in the adding a phosphoric acid solution, a mixing ratio of the eggshell to the phosphoric acid solution ranges from 1:1.3 to 1:1.7 by weight.

8. The method according to claim 7, wherein the mixing ratio of the eggshell to the phosphoric acid solution ranges from 1:1.3 to 1:1.5 by weight.

9. The method according to claim 6, wherein the polymer in the drying, calcining the gel solution to form powder and then pulverizing the synthesized powder is polyethylene glycol.

10. The method according to claim 9, wherein the polymer has a molecular weight of 500˜3500.

11. The method according to claim 6, wherein, in the adding a phosphoric acid solution, a weight ratio of total calcium ions to the polymer ranges from 3:1 to 1:1.

12. The method according to claim 6, wherein, in the drying, calcining the gel solution to form powder, the calcining is conducted at atmospheric pressure at a temperature of 850˜950° C. for 0.5˜2 hours.

13. A highly-sinterable calcium phosphate-based ceramic powder prepared using the method of claim 3.

14. The highly-sinterable calcium phosphate-based ceramic powder according to claim 13, wherein the powder has a particle size of 50˜500 nm.

15. The highly-sinterable calcium phosphate-based ceramic powder according to claim 13, wherein the powder has a specific surface area of 50˜70 m²/g.

16. A highly-sinterable calcium phosphate-based ceramic powder prepared using the method of claim 6.

17. The highly-sinterable calcium phosphate-based ceramic powder according to claim 16, wherein the powder has a particle size of 50˜500 nm.

18. The highly-sinterable calcium phosphate-based ceramic powder according to claim 16, wherein the powder has a specific surface area of 50˜70 m²/g.

19. A method of preparing a highly densified calcium phosphate-based ceramic compact, comprising:
molding and sintering the calcium phosphate-based ceramic powder prepared using the method of claim 3.

20. The method according to claim 19, wherein the sintering the calcium phosphate-based ceramic powder is conducted at a temperature of 1200˜1300° C. for 0.5˜2 hours.

21. A method of preparing a highly densified calcium phosphate-based ceramic compact, comprising:
molding and sintering the calcium phosphate-based ceramic powder prepared using the method of claim 6.

22. The method according to claim 21, wherein the sintering the calcium phosphate-based ceramic powder is conducted at a temperature of 1120˜1180° C. for 0.5˜2 hours.

23. A highly densified calcium phosphate-based ceramic compact prepared using the method of claim 19.

24. A highly densified calcium phosphate-based ceramic compact prepared using the method of claim 21.
